(19) United States
(12) Patent Application Publication
(10) Pub. No.: US 2026/0252087 A1
(43) Pub. Date: Aug. 27, 2026

(54) METHOD, APPARATUS AND COMUTER PROGRAM FOR SCANNING A PLURALITY OF OBJECT PARTS OF AN OBJECT ARRANGED ADJACENT TO ONE ANOTHER IN AN OBJECT ENVIRONMENT

(71) Applicant: TOP SEVEN GMBH & CO. KG, Munich (DE)

(72) Inventors: Oliver NEUBAUER, Gauting (DE); Markus WIEDEMANN, Grossweil (DE); Anand PATEL, Munich (DE)

(21) Appl. No.: 19/650,467

(22) Filed: Apr. 17, 2026

Related U.S. Application Data
(63) Continuation of application No. PCT/EP2024/078970, filed on Oct. 15, 2024.

(30) Foreign Application Priority Data
Oct. 18, 2023 (DE) 102023210232.3

(51) Int. Cl. G05D 1/246; G05D 1/644; G05D 1/689; G05D 105/80; G05D 107/70; G05D 109/25; G05D 111/10

(52) U.S. Cl. CPC G05D 1/246; G05D 1/6445; G05D 1/689; G05D 2105/89; G05D 2107/75; G05D 2109/254; G05D 2111/10

(57) ABSTRACT

Method for scanning a plurality of object parts of an object arranged adjacent to one another in an object environment, the method comprising the following steps: (a) positioning a movable capturing unit on a first object part; (b) generating a scan of the first object part using a movable capturing unit; and (c) determining a trajectory towards a second object part arranged adjacent to the first object part, moving the movable capturing unit using the trajectory towards the second object part, and generating a scan of the second object part using the movable capturing unit.

### CROSS-REFERENCE TO RELATED APPLICATIONS

This application is a continuation of copending International Application No. PCT/EP2024/078970, filed Oct. 15, 2024, which is incorporated herein by reference in its entirety, and additionally claims priority from German Application No. 102023210232.3, filed Oct. 18, 2023, which is also incorporated herein by reference in its entirety.

Embodiments of the present invention include methods, apparatuses and computer programs for scanning a plurality of object parts of an object arranged adjacent to one another in an object environment.

Embodiments include, in particular, apparatuses and methods for the autonomous inspection of flat objects that are unknown, or at least partially unknown, by means of exploration.

### BACKGROUND OF THE INVENTION

The inspection of large-scale industrial facilities is a key factor in ensuring smooth and efficient operations, not only in terms of the facility's cost-effectiveness but also in terms of compliance with safety standards. However, this area of application presents a number of challenges.

Firstly, such inspection methods should be as efficient as possible, as the sheer size of such facilities, such as large wind farms or large outdoor photovoltaic systems, would otherwise result in very high costs due to the significant amount of time needed. Furthermore, in some facilities, extended downtime for inspection may simply not be feasible.

Furthermore, some of the elements to be inspected are often difficult to access or are even located in areas of the facility that are hazardous to humans, meaning that the traditional deployment of inspection personnel is not possible here, or would involve considerable risks.

Furthermore, in some cases, precise details of the facility's location, such as a map or site plan, may not be available. Particularly in the case of large industrial facilities, which may have been expanded and refurbished over the years, it is by no means a simple task to ensure that up-to-date site plans are available.

There is therefore a need for an efficient concept for scanning large-scale objects, for example for inspections.

### SUMMARY

According to an embodiment, a method for scanning a plurality of object parts of an object arranged adjacent to one another in an object environment may have the steps of:
(a) positioning a movable capturing unit on a first object part;
(b) generating a scan of the first object part using the movable capturing unit; and
(c) determining a trajectory towards a second object part arranged adjacent to the first object part, moving the movable capturing unit using the trajectory towards the second object part, and generating a scan of the second object part using the movable capturing unit;
   wherein the step (c) includes evaluating a map of the object environment with the object regarding a position of the second object part for determining the trajectory, and/or wherein the step (c) includes evaluating the scan of the first object part regarding a position of the second object part for determining the trajectory, wherein the scan generated in step (b) at least partially shows the second object part, and/or wherein a relative location of the second object part relative to the first object part is known.

Another embodiment may have a non-transitory digital storage medium having a computer program stored thereon to perform the inventive method for scanning a plurality of object parts of an object arranged adjacent to one another in an object environment, when said computer program is run by a computer.

Another embodiment may have an apparatus for scanning a plurality of object parts of an object arranged adjacent to one another in an object environment, wherein the apparatus includes a processing unit and a capturing unit; wherein the capturing unit is configured to be positioned at a first object part and to generate a scan of the first object part; wherein the processing unit is configured to determine a trajectory towards a second object part adjacent to the first object part; wherein the scan of the first object part at least partially shows the second object part and/or wherein a relative location of the second object part relative to the first object part is known, and wherein the processing unit is configured to evaluate the scan of the first object part regarding a position of the second object part for determining the trajectory; and/or wherein the processing unit is configured to evaluate a map of the object environment with the object regarding a position of the second object part for determining the trajectory; and wherein the capturing unit is configured to move towards the second object part using the trajectory and to generate a scan of the second object part.

Embodiments according to the present invention include a method for scanning a plurality of object parts, e.g. of photovoltaic panels, of an object, e.g. a photovoltaic system, arranged adjacent to one another in an object environment, e.g. the facility site, wherein the method comprises the following steps:
(a) positioning a movable capturing unit, e.g. a drone, at a first object part, e.g. positioning the movable capturing unit at a predetermined position relative to the first object part. The step (a) may therefore, for example, comprise approaching the first object part and/or, for example, positioning the movable capturing unit near the first object part;
(b) generating a scan, e.g. an optical scan, e.g. an ultrasonic and/or radar scan, of the first object part by means of the movable capturing unit; and
(c) determining a trajectory, e.g. a flight trajectory, towards a second object part adjacent to, e.g. the nearest, first object part, moving the movable capturing unit by means of the trajectory to the second object part, i.e. e.g. approaching the second object part using the flight trajectory using the movable capturing unit (e.g. reaching the second object part), and generating a scan, e.g. an optical scan, of the second object part by means of the movable capturing unit.

The step (c) comprises evaluating a map of the object environment with the object regarding a position of the second object part for determining the trajectory (e.g. the flight trajectory).

Alternatively or in addition to this, the step (c) comprises evaluating the (e.g. optical) scan of the first object part regarding a position of the second object part for determining the trajectory (e.g. flight trajectory), wherein the (e.g. optical) scan generated in step (b) at least partially shows the second object part, e.g. such that the second object part can be recognised by means of image analysis, and/or wherein a relative location of the second object part relative to the first object part is known, wherein, for instance, a relative location between the capturing unit and the first object part is determined, and based on a known relative location between the first and second object parts, the location between the capturing unit and the second object part is determined.

Embodiments according to the present invention are based on the idea of performing object scanning using a movable capturing unit, e.g. automatically or autonomously.

The inventors have recognised that evaluating map data relating of the object environment with the object and/or scanning the first object part enables the efficient determination of a trajectory for the movable capturing unit.

If, e.g., sufficiently accurate map information is available, a corresponding trajectory for scanning can be calculated. However, as will be explained in more detail, embodiments also allow, as an option, the mapping of the object and the object environment for generating a corresponding map.

Alternatively, or in addition, the trajectory may also be determined using the scan, e.g. based on evaluating the relative position of the capturing unit and the second object part recognised in the scan.

Optionally, the trajectory may also be determined by detecting the relative location of the first object part to the capturing unit and by means of an information regarding the relative location of the first object part to the second object part. By evaluating the scan, the relative location between the capturing unit and the first object part can be determined, wherein this can then be converted into a relative location between the capturing unit and the second object part using the known relative location between the first and second object parts.

Thus, embodiments enable trajectory determination, e.g. flight trajectory determination, and consequently also scanning objects, even when there is no, or almost no, information available regarding the relative location of object parts.

The scanning may, for example, comprise or consist of optical scanning, such as camera scanning, and/or laser scanning, such as LIDAR scanning. It is also conceivable to use additional or alternative scanning techniques, such as radar sensors, ultrasonic sensors or thermal scanning units.

The movable capturing unit may, for example, include a drone or be a drone configured to fly around the object and the object environment. However, the movable capturing unit may also be a module for a suitable vehicle, such as a drone, which can only move autonomously when attached to the vehicle. For instance, the use of wheel-or chain-driven vehicles is also conceivable in this context. Climbing robots, or at least robots capable of climbing, may also be used.

In addition to drones, submersible vehicles may also be used as movable capturing units for this purpose, e.g. to inspect large-scale underwater facilities. These may then be equipped with e.g. ultrasonic and/or optical sensors. In general, ultrasonic scanning can e.g. produce scan results or images similar to optical scanning.

The object may be any type of facility, such as a large-scale one, including a multitude of object parts. As mentioned above, the object may e.g. be a photovoltaic system with a multitude of photovoltaic panels. The object parts may be the individual photovoltaic panels, or entire rows of photovoltaic panels. Furthermore, the object may also be e.g. a network of pipes in a large-scale industrial facility, in which case the object parts may be individual pipe sections. However, embodiments are not limited to specific configurations of the object as a large-scale structure. The methods according to the invention may also be applied to objects on a smaller scale.

According to embodiments, the trajectory may take the form of, e.g., waypoints, motion vectors (such as flight, driving and/or swimming vectors), or control commands for the capturing unit. The trajectory may, e.g., be georeferenced (e.g. GPS-referenced, such as in the form of GPS coordinates) or may also be expressed as relative information (e.g. approaching, heading towards, or navigating to a position in a specific relative location to an object part). A relative location or position may e.g. be based on a coordinate system associated with the object or with the capturing unit (which thus forms e.g. the coordinate origin).

The map may be a georeferenced map, e.g. one associated with GPS coordinates, or simply a collection of relative positional data, such as an information about distances and/or relative locations of object parts in relation to one another. For instance, the map may also include a plan view and/or a dimensions plan of the property.

By way of illustration, an embodiment according to the present invention is summarised briefly as follows:

### Options

1. Map available
   a. positioning the movable capturing unit on the first object part (e.g. by approaching)
      i. navigating to the second object part using image analysis, and/or
      ii. navigating to the second part using the map
2. No map available
   a. proceeding with mapping as in 1, or
   b. positioning the movable capturing unit on the first object part (e.g. manually positioning the capturing unit, e.g. because there is as yet no information regarding the first object part for automatic navigation, such as an automatic approach)
      i. approaching or navigating to the first object part, as it is known from that point onwards that the capturing unit (e.g. a drone) is positioned directly in front of it (e.g. using the known relative location or image analysis, thereby enabling detection of the first object part)
      ii. navigating to the second object part using image analysis

According to embodiments, the step (a) may further optionally comprise: obtaining or determining an information regarding the position of the first object part (e.g. a final object part in a group of object parts, or e.g. an object part situated in the middle of object parts of a group of object parts) and moving the movable capturing unit to the first object part, i.e. e.g. approaching the first object part using the movable capturing unit by means of the information regarding the position of the first object part.

The information regarding the position of the first object part may, for instance, be a rough estimate of its position; e.g., by using an existing map of the object environments with the object, e.g. by positioning the movable capturing unit near the first object part (e.g. at a predetermined relative location), or by using an evaluation of a (e.g. optical) scan.

This means that scanning can be carried out even without, or with only limited prior knowledge of, the position of the first object part.

According to embodiments, the method may further comprise at least one of determining information regarding the position of the first object part based on the map, positioning the capturing unit in a predetermined relative location to the first object part and providing an information regarding the predetermined relative location as an information regarding the position of the first object part. and/or positioning the capturing unit near the first object part, such that the capturing unit can detect the first object part and determine an information regarding the position of the first object part.

Put simply, the starting position may therefore be found, e.g., using a map, by means of a known orientation of the capturing unit, such as a drone, to the first object part, and/or by positioning the capturing unit near the first object part and then analysing the image, e.g. through image recognition.

This means that, depending on the specific application, the available information can be utilised as effectively as possible.

According to embodiments, the method may further comprise generating a map of the object environment with the object. This means for instance, that a mapping phase may be carried out prior to the method, thereby enabling scanning to take place without prior knowledge of the location.

According to embodiments, generating the map of the object environment with the object can be carried out based on the current position, an orientation and/or a distance measurement of the movable capturing unit (e.g. of the object environment and/or object parts). Taking into account sensor information from the movable data capturing unit enables precise mapping, e.g. with regard to estimating measurement and/or model uncertainties that affect the mapping. According to embodiments, the map may, in particular, be georeferenced.

According to embodiments, the method may further comprise the following optional features: moving the movable capturing unit to a first mapping position, i.e. e.g. approaching a first mapping position, such as any position in terms of longitude and latitude, but at a predetermined altitude (or e.g. a depth of submergence), such as a defined search level, using the movable capturing unit; generating and evaluating a (e.g. optical) scan of at least a part of the object environment with at least a part of the object; updating the map and/or generating at least a part of a or the map of the object environment with the object, based on the evaluation of the scan.

Provided that the map comprises an information, e.g. an information meeting a predetermined confidence measure, regarding the position of the first and/or second object part, it is also conceivable to determine the position of the first object part using the map; and/or to determine the position of the second object part using the map for determining the trajectory (e.g. the flight trajectory).

Alternatively or additionally, the method may further include moving the movable capturing unit to a further mapping position, e.g., by approaching a further mapping position by means of the movable capturing unit, generating and evaluating a further (e.g. optical) scan of at least a part of the object environment with at least a part of the object, and updating the map and/or generating at least a further part of the map of the object environment with the object based on the evaluation of the scan.

Such a procedure, i.e. e.g., flying over several mapping positions, may be carried out until the map comprises an information, e.g. an information meeting a predetermined confidence measure, regarding the position of the first and/or second object part (e.g. to commence an inspection) or, e.g., until the map fully comprises or represents the object environment with the object.

In simplified terms, a method according to embodiments may, e.g., include the following steps with regard to mapping:
1. Map available:
   a. updating an existing map by scanning, and/or
   b. generating a new part of the map
2. No map available:
   a. generating the map
3. In both cases (optional)
   a. repeating the scanning iteratively at different positions is possible until:
      i. detecting the position of the first object part for navigating, i.e. e.g. approaching and/or
      ii. detecting the position of the second object part for trajectory planning

This allows a mapping information to be generated in a flexible and robust manner.

According to embodiments, the method may further optionally comprise: orienting a (e.g. optical, electromagnetic and/or acoustic) scanning unit of the capturing unit substantially perpendicular to a surface of the object environment, i.e. e.g. perpendicular downwards towards the ground, and generating the (e.g. optical) scan of the at least one part of the object environment whilst moving the movable capturing unit (200) to the first mapping position, i.e. e.g. whilst approaching the first mapping position.

This type of scanning may therefore be carried out, e.g., as a drone ascends above the environment the object. In particular, this means that an approach trajectory to an initial mapping point can already be used for mapping. Furthermore, images taken perpendicular to the ground may exhibit a lower measurement inaccuracy, enabling the generation of initial map points with particularly high accuracy. The same applies to the use of underwater robots and underwater photography.

According to embodiments, the method may further optionally comprise: reaching the first mapping position with the movable capturing unit, changing the orientation of the (e.g. optical) scanning unit of the capturing unit, and rotating the scanning unit or the capturing unit for generating an (e.g. optical) scan of at least a part of the object environment with at least a part of the object. Put simply, this means that the number of waypoints needed for mapping can be reduced by panning the capturing unit (and/or scanning unit).

According to embodiments, updating the map and/or generating at least a part of the map of the object environment with the object, based on the evaluation of the (e.g. optical) scanning, further comprises determining a confidence measure for parts of the map associated with the (e.g. optical) scanning, such as individual pixels. This also enables a stochastic evaluation of the mapping, which can improve trajectory planning.

According to embodiments, the confidence measure for associated parts of the map may be determined based on a distance and/or an angle between a line of sight of the capturing unit and a vertical line to the ground, such that, e.g., pixels with a line of sight perpendicular to the ground may be assigned a higher confidence than pixels whose line of sight forms a greater angle with the vertical line to the ground. The inventors have recognised that a distance and/or an angle between the line of sight of the capturing unit and a vertical line to the ground can influence the accuracy of the mapping results and can therefore be used as a robust approximation for a confidence information.

However, the term ‘line of sight’ does not refer solely to optical scanning units; it also describes e.g. the line of sight in ultrasonic or radar scanning. In this context, the line of sight describes e.g. a main direction in which the scanning unit can ‘see’ its environment by means of scanning. In the case of wave-based scanning, the line of sight therefore generally describes a principal direction of wave propagation, such as a direction vector of the wave (e.g. originating from the capturing unit). For example, the line of sight may correspond to the main axis of a corresponding radar beam. The line of sight may therefore describe e.g. a scanning direction or the main scanning direction of the scan.

According to embodiments, updating the map and/or generating at least a part of the map of the object environment with the object and/or determining confidence measures is carried out by means of a stochastic filter, e.g. a Kalman filter, to account for erroneous scanning results. This allows an efficient implementation of mapping.

According to embodiments, the method may further comprise detecting the first and/or second object part in a (e.g. optical) scan and determining a confidence measure for the detection of the first and/or second object part. For example, a corresponding confidence may be determined based on the detected area of the object part (e.g. using a specific threshold value for the area or a specific degree of correspondence with the expected area of the object part in question). This helps to improve the accuracy and reliability of the mapping.

According to embodiments, the map or the part of the map may be stored in a continuous form. The map or the part of the map may e.g. be stored in the form of a matrix, wherein fields of the matrix represent a map section with a defined resolution and/or size. The method may further comprise creating and/or updating a corresponding map section when an optical scan relating to that area is captured. This means that even large volumes of data (e.g. large maps) can be processed efficiently and made accessible.

In a matrix, the area can, e.g., be distributed evenly. For example, each entry in such a matrix may represent an area of equal size comprising the object and/or the object environment. Furthermore, corresponding matrix elements may have the same or different resolutions.

In general, however, according to embodiments, areas of different sizes and/or resolutions, e.g. contiguous areas, may also be stored if desired. But that wouldn't be an even distribution, for example. For example, individual map parts may each cover areas of the object and/or the object environment that differ in size. The resolution of the different areas may be the same or different in each case.

For example, individual parts of a map may each have a consistent storage requirement, wherein less important sections of an object and/or object environment are stored at a lower resolution, covering a larger area, whilst important sections of an object and/or object environment are stored at a higher resolution, covering a smaller area.

Consequently, maps or parts thereof may therefore only be stored in a contiguous form, without object parts or object environment parts being represented uniformly in terms of area and/or resolution.

One advantage of this approach is the ability e.g. to group empty areas such as lakes or undeveloped land (in the case of a solar park, areas without solar panels; e.g. parts of the object environment) into low-resolution representations, thereby saving storage space and computing power. Another advantage could, of course, be the exact opposite scenario, such as using a higher resolution for complex areas (e.g. parts of the object), if needed or desired.

According to embodiments, the method further comprises updating the map based on the (e.g. optical) scanning of the first and/or second object part; in other words, e.g. an update based on evaluation results. Mapping can therefore be further refined, particularly during an inspection or scan. In other words, any information captured whilst the scanning unit is in motion, e.g. during flying over, can be used to continuously update a mapping. For example, higher-resolution scans can be ‘captured’ when approaching object parts that are relevant for inspection, such as when flying towards them. Thus, an efficiency of the method can be enhanced.

According to embodiments, the object comprises several groups of object parts arranged adjacent to one another, wherein a first group of object parts comprises at least the first and second object parts. The method may further comprise moving the movable capturing unit along the first group of object parts, e.g. flying over and optically sensing the first group of object parts; detecting that the first group of object parts has been fully scanned; and determining a trajectory towards a second group of object parts arranged adjacent to one another based on the map. Making use of information regarding groupings of object parts (e.g. a row of photovoltaic panels) enables an efficient trajectory planning even when there is little prior information available.

According to embodiments, the map or a part of the map comprises additional information, wherein the additional information comprises at least one of an information indicating whether the map or the part of the map comprises a specific object part; an information indicating whether an object part has already been inspected, is currently being inspected, or is yet to be inspected; and/or a confidence of the respective information, i.e. e.g. additional information, of the map or the part of the map.

Generating and evaluating this additional information enables an efficient trajectory planning and inspection planning.

According to embodiments, the (e.g. optical) scan generated in the step (b) may show at least partially the second object part, and the method may further optionally comprise: detecting the second object part in the (e.g. optical) scan generated in the step (b), obtaining, e.g. retrieving or determining, an information regarding the geometry of the second object part, determining, based on the information regarding the geometry of the second object part, a relative inspection position of the movable capturing unit for inspecting the second object part, such that an associated (e.g. optical) scan shows the second object part in a predetermined image area, and moving the movable capturing unit towards, i.e. e.g. approaching, the relative inspection position. In other words, this means that fine-tuning of the trajectory planning, such as flight path planning, can be carried out based on current scans. This enables an efficient trajectory planning for precise scanning. In particular, an image section may also be set in accordance with boundary conditions of the scanning, such as the desired resolution of the object, which can be achieved by adjusting the trajectory, e.g. the flight trajectory, or by adjusting the zoom settings.

According to embodiments, evaluating the map of the object environment with the object regarding a position of the second object part may further comprise: obtaining, e.g. retrieving or determining, an information regarding the geometry of the second object part and determining a relative inspection position of the movable capturing unit for inspecting the second object part, such that an associated (e.g. optical) scan comprises the second object part in a predetermined image area. The method may also comprise moving the movable capturing unit, e.g. approaching the relative inspection position. In other words, this means that fine-tuning of the trajectory planning, such as flight path planning, can be carried out based on the mapping. This enables also an efficient trajectory planning for precise scanning. It is therefore also possible to set the desired resolution.

According to embodiments, the method may further comprise: detecting, whilst moving the movable capturing unit to the first object part, e.g., when approaching the first object part by means of the movable capturing unit, a further object part to be scanned, comparing the distance between the capturing unit and the first object part with the distance between the capturing unit and the second object part, and replacing the second object part with the further object part to carry out steps (a) to (c). Thus, when navigating to an object part, another object that is also to be scanned, and which, e.g., is unexpectedly detected whilst approaching the first object part, can be used as a new starting point, which can save time.

According to embodiments, the object may be an outdoor photovoltaic system with a plurality of photovoltaic panels arranged adjacent to one another. The inventors have recognised that the trajectory planning according the invention is particularly efficient when applied to the arrangement of photovoltaic panels (groups) and can lead to good scanning and inspection results.

According to embodiments, the method may further comprise: inspecting the first object part by means of (e.g. optical) scanning of the first object part and/or inspecting the second object part by means of (e.g. optical) scanning of the second object part.

Further embodiments include a computer program with program code for carrying out methods according to embodiments.

Further embodiments include an apparatus for scanning a plurality of object parts arranged adjacent to one another, e.g. photovoltaic panels, of an object, e.g. a photovoltaic system, in an object environment. The apparatus may comprise a processing unit and a capturing unit, wherein the capturing unit is configured to be positioned at a first object part and to generate a (e.g. optical) scan of the first object part. Furthermore, the processing unit may be configured to determine a trajectory, e.g. a flight trajectory, towards a second object part adjacent to the first object part, wherein the (e.g. optical) scan of the first object part may at least partially show the second object part and/or wherein a relative location of the second object part to the first object part may be known, and wherein the processing unit may be configured to evaluate the (e.g. optical) scan of the first object part regarding a position of the second object part in order to determine the trajectory. Alternatively or additionally, the processing unit may be configured to evaluate a map of the object environment with the object regarding a position of the second object part for determining the trajectory. Furthermore, the capturing unit may be configured to approach the second object part using the trajectory and to generate a (e.g. optical) scan of the second object part.

Apparatuses according to the present invention may be based on the same, similar or corresponding ideas and considerations as corresponding methods. Apparatuses according to embodiments may, in particular, include features, functionalities and details, in the same or a corresponding form, which have been disclosed in the context of methods, both individually and in combination.

### BRIEF DESCRIPTION OF THE DRAWINGS

With regard to the schematic figures shown, it should be noted that the functional blocks depicted are to be understood both as elements or features of the apparatus according to the disclosure and as corresponding method steps of the method according to the disclosure, and that corresponding method steps of the method according to the disclosure may also be derived from them. Embodiments of the present invention will be detailed subsequently referring to the appended drawings, in which:

FIG. 1 is a schematic representation of an object in an object environment according to embodiments of the present invention;

FIG. 2 is a schematic representation of an object in an object environment, as well as a capturing unit during a mapping of the object environment according to embodiments of the present invention;

FIG. 3 is a schematic side view of a capturing unit in the form of a drone during scanning at a first mapping position according to embodiments of the present invention; and

FIG. 4 is a schematic block diagram of a method according to embodiments of the present invention.

### DETAILED DESCRIPTION OF THE INVENTION

Before the following embodiments of the present invention are explained in more detail with reference to the drawings, it is pointed out that identical, functionally identical or similarly acting elements, objects and/or structures are provided with the same or similar reference signs in the different figures, so that the description of these elements shown in different embodiments is interchangeable or can be applied to one another.

With regard to the following figures, it should be noted that a representation of the field of view of the capturing unit may e.g. reflect the field of view of an associated scanning unit. Accordingly, the areas shown may correspond to the areas for which information is available in the respective scan, that is, they represent the respective scans. Based on an according evaluation, these areas also correspond to (or represent) associated map areas for instance (for example with information in a processed form).

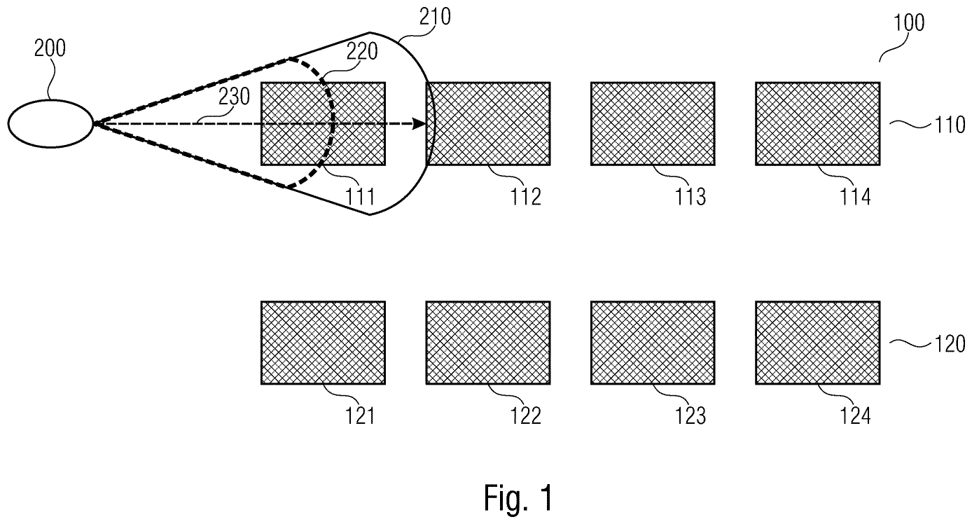

FIG. 1 shows a schematic representation of an object in an object environment according to embodiments of the present invention.

FIG. 1 shows a schematic top view of a plurality of object parts 111 to 124 of an object 100, as well as a movable capturing unit 200. Some of the object parts are arranged adjacent to one another, such as object parts 111 to 114 and object parts 121 to 124. The object parts 111 to 124 could, e.g., be panels of a photovoltaic system, which are arranged in several rows 110 and 120. The object may therefore include, e.g., several groupings or groups 110, 120 of object parts. The object environment may, e.g., include the areas in which object parts are located, as well as the environment areas between the object parts. The environment therefore includes, e.g., the entire site of a facility, or, in the case of a factory, the factory premises, or at least parts thereof.

According to embodiments, a method according to the invention comprises positioning (step (a)) the movable capturing unit 200 at a first object part 111. The capturing unit 200 is then used to generate a (e.g. optical) scan. For example, a first possible viewing or scanning area 210 and a second possible viewing or scanning area 220 of the scanning, i.e. respective areas in relation to which scanning information can be found in the scan, are shown in FIG. 1.

Furthermore, based on the position of the capturing unit 200, a trajectory 230 can be determined to a second object part 112 adjacent to the first object part 111. The second object part 112 can then be approached based on the determined trajectory 230 in order to generate a (e.g. optical) scan of the second object part 112 using the movable capturing unit 200.

The trajectory 230 may be determined using various pieces of information. On the one hand, for instance, map information of the object environment, such as at least one map section that includes e.g. the current position of the capturing unit 200 and position information regarding the first and second object parts (or from which such position information can be determined), may be evaluated to determine the trajectory 230.

The map may e.g. be georeferenced, so that the capturing apparatus 200 can determine the trajectory 230 based on its own GPS position. However, the map may not be available in a georeferenced version, e.g. in the case of dimensioning or development plans, so that the capturing unit 200 can optionally determine its own location on the map using environment features, such as the first object part 111. The relative location between the first and second object parts may then be determined from the mapping, e.g. to determine the trajectory 230.

The trajectory 230 may therefore also be georeferenced, or it may be available as relative information, e.g. as a sequence of control commands, originating from the capturing unit 200.

However, determining the trajectory may also be carried out independently of a map, if desired. Thus, the trajectory 230 may be determined based on the detection of the first object part 111 in the (e.g. optical) scan and knowledge of the relative location between the first and second object parts.

Another possibility arises if the (e.g. optical) scanning, as shown e.g. with the viewing or scanning cone 210, shows at least a part of the second object part 112. The trajectory 230 may then also be determined based on (e.g. optical) scanning.

According to embodiments, these approaches can be used as alternatives or in parallel with one another, e.g. to enable a particularly robust determination of the trajectory 230.

As an optional feature, a method according to the invention may further comprise obtaining, determining or generating an information regarding the position of the first object part 111 for the purpose of positioning the movable capturing unit 200. This can be done e.g. using an existing map, thereby enabling the movable capturing unit to move from any starting position to the first object part. Another option is to position the capturing unit manually near the first object part 111, for example. In such a case, the capturing unit 200 may e.g. be provided with an information regarding the relative location between the capturing unit 200 and the first object part 111, in order to enable subsequent movement towards the first object part. For example, the capturing unit 200 may be positioned at a specific distance from a predetermined side of the first object part 111. Furthermore, however, the capturing unit 200 may e.g. also be positioned such that the first object part lies within a scanning (see for instance scanning areas 210, 220), so that a corresponding process can be carried out automatically, e.g. by means of object recognition and distance measurements.

Optionally, a method according to the embodiments may further include generating a corresponding map of the object environment. Alternatively, an existing map, e.g. one that is out of date or inaccurate, may be updated, for instance by replacing parts of the map and/or adding new parts.

For this purpose, the capturing unit 200 for instance may be used in preparation to the scanning steps described above (or in parallel with them). Depending on the specific application, a method according to the invention may comprise a plurality of steps. For example, a mapping may involve a rough scan of the object environment in order to obtain an information that is sufficiently accurate, at least for navigating. Based on this, a more detailed scanning of the individual object 111 to 124 may be carried out in a second step. However, it is of course also possible to generate scans of object parts relevant to inspection during the mapping. In particular, it should be noted that the inventors have recognised that updating the map using scanning data, e.g. by means of a second step to inspect the object parts, constitutes an efficient way of utilising scanning data as efficiently as possible (i.e. for inspection and, at the same time, for mapping or, in particular, for improving the map).

To ensure the precise association of scan information with such a map, factors such as the current position of the capturing unit 200, an orientation of the capturing unit 200 and/or a distance measurement of the capturing unit 200 may be taken into account. In particular, the map can be created as a georeferenced map, e.g. by associating the scan information with the location data from the capturing unit 200.

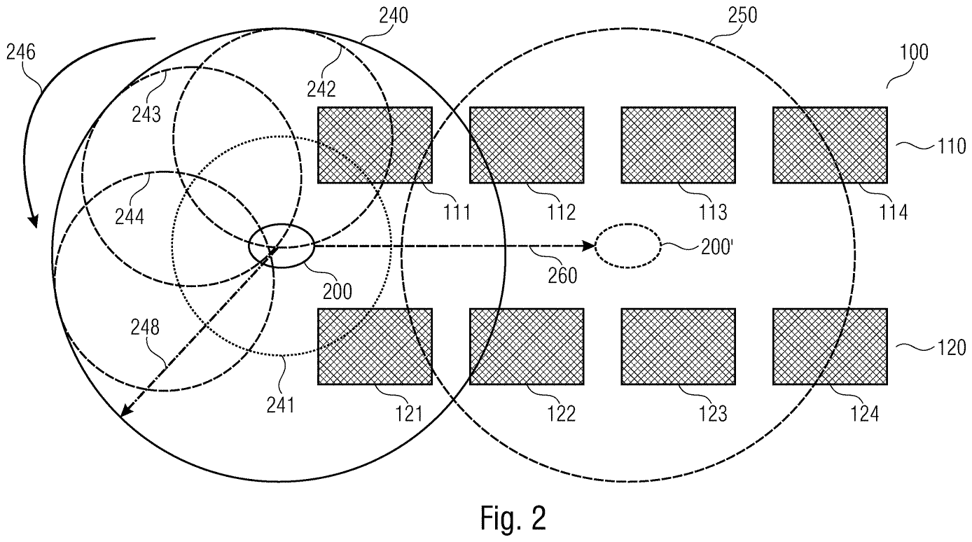

Further optional features of the mapping according to the invention are explained below with reference to FIG. 2. FIG. 2 shows a schematic representation of an object in an object environment, as well as a capturing unit during the mapping of the object environment according to embodiments of the present invention.

FIG. 2 shows the object 100 from FIG. 1, as well as the capturing unit 200 at a first mapping position. It should be noted that various scanning units and/or capturing units may also be used for mapping and inspection scanning.

The first mapping position may, e.g., be any lateral position in the object environment, such as one that is easily accessible, but may also be defined by a predetermined vertical height, such as a predetermined search level. The search level may e.g. be determined on the basis of the object size and the resulting needed scanning area of the imaging unit 200, taking into account, for instance, a minimum resolution needed for object detection.

For mapping, e.g., the mapping position may be approached first. This may for instance include a straight, vertical ascent. Subsequently, one or more (e.g. optical) scans can be generated (e.g. even whilst the capturing 200 is ascending). An example of this is shown in FIG. 2 as the scanning area 241, which represents e.g. a field of view (e.g. ‘vertically downwards’) from the first mapping position.

For this purpose, a (e.g. optical) scanning unit of the capturing unit 200 may optionally be oriented substantially perpendicular to a surface of the object environment, i.e. e.g., perpendicular downwards towards the floor (see the circular field of view 241, directly below the capturing unit 200 in FIG. 2).

Upon arrival at the mapping position, e.g. at the desired altitude, an orientation of the scanning unit of the capturing unit 200 may then be changed if needed, and the scanning unit and/or the capturing unit may be rotated.

This means that the area of the image that can be scanned can be significantly enlarged starting from the first mapping position. By changing the orientation, the area 242 may be scanned, for example; a rotation 246 with the changed orientation may then be combined to a cumulative information for the area 240, as indicated by the further areas 243 and 244. The individual scans may be evaluated separately, or combined into a single scan, e.g. by stitching them together to form a complete image.

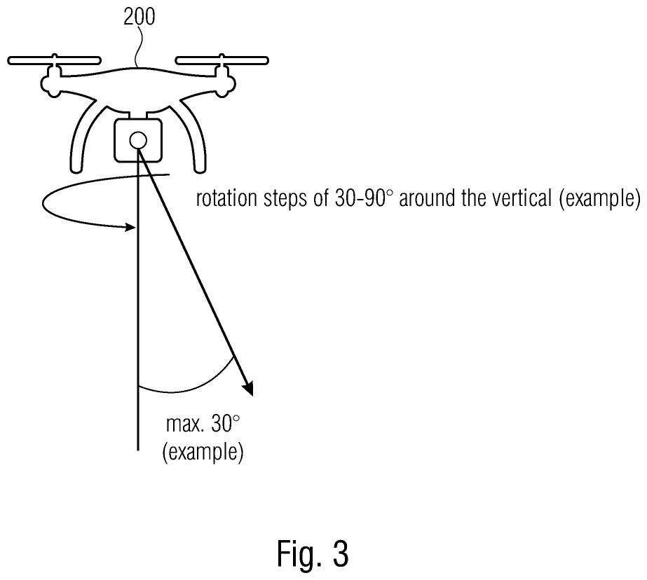

Reference is made to FIG. 3, which shows an example of how the scans are generated for the area 240. FIG. 3 shows a schematic side view of a capturing unit, as an example in the form of a drone able to fly, during scanning at a first mapping position according to embodiments. The angles and angle ranges are given merely as examples. The changes in orientation and rotation are indicated. As shown in FIG. 3, once the first mapping position has been reached, for example, the angle of the scanning unit can be adjusted (here e.g. by a maximum of 30°) in order to subsequently initiate a rotation, thereby generating the areas 242 to 244 indicated in FIG. 2.

At this point, however, it should be explicitly noted that the exact sequence of the scanning, e.g. scanning ‘vertically downwards’ first, followed by changes to the orientation and rotation, is merely optional. Other approaches are also possible, e.g. depending on the topology of the object environment and the object.

Using the generated scan information (i.e. one or more of the sections 241 to 248, or a sub-area or the entire area of 240), an existing map may then be updated, or at least a part of a new map may be generated. Image analysis methods, for example, may be used for this purpose. The evaluation may be carried out online, e.g. to display a mapping progress in real time, or retrospectively, e.g. following a mapping flight. Furthermore, the evaluation may be carried out on-board, i.e. using the capturing unit 200, or e.g. on an external computing unit using a suitable data connection.

As shown as an example in FIG. 2, a first object part 111 and a second object part 112 may already be represented within the first scanning area 240. Accordingly, provided that the map newly generated or updated on the basis of the evaluation contains sufficient information, e.g. an information that meets a predetermined confidence measure, regarding a position of the first and/or second object part, the position of the first object part can be determined using the map and/or the position of the second object part can be determined.

It is therefore possible at this point to proceed e.g. with the scanning described in the context of FIG. 1, i.e. e.g. in the sense of an inspection scan. The map may be expanded e.g. by taking further samples as the trajectory 230 is flown.

Alternatively, and in particular if the area 240 does not include a first and/or second object part, a further mapping position may be approached (e.g. by flying towards it) using the movable capturing unit 200 in order to generate a further (e.g. optical) scan of at least a part of the object environment, and to update or expand the map.

However, may can also be done in the case shown in FIG. 2, in order to first generate a map that is as accurate or comprehensive as possible. Such a mapping can e.g. be carried out until a known number of object parts to be scanned has been mapped. Determining a trajectory 260 for navigating (e.g. for an approach) towards a further mapping position (see 200′—new position of the capturing unit 200 and new image area 250) may, in turn, be carried out on the basis of known, e.g. old, map information, e.g. by analysing the image of the section 240 (or parts thereof, in particular taking into account known position information regarding the object parts), or may e.g. also be carried out by means of a random movement (e.g. at least laterally) in a search direction (or e.g. based on a knowledge of the extent and location of the object environment).

The inventors have also recognised that such sampling methods can be improved by taking confidence measures into account. Thus, when updating the map and/or generating at least a part of the map, a confidence measure may optionally be determined for those parts of the map associated with a particular (e.g. optical) scan.

In other words, it is possible to determine a measure of how reliable an information derived from an evaluation of a given scan is. In this context, factors such as the distance and/or angle between the line of sight of the capturing unit 200 and a vertical line to the ground may be taken into account; see e.g. FIG. 3 and the different lateral fields of view or scanning areas shown in FIG. 2 (e.g. 241, as opposed to 242 to 244). In particular, stochastic filters may be used for this purpose.

In this context, the inventors have recognised that evaluations based on pixels where e.g. the scanning and/or line of sight axis is essentially perpendicular to the ground can have a higher confidence than pixels where the scanning and/or line of sight axis has a greater angle with the vertical line to the ground. As the angle and distance 248 from the vertical line to the ground of the capturing unit (e.g. a drone) increase, the interpretability or reliability of the evaluation information if image parts of (e.g. optical) scans may be reduced, e.g. due to distortion effects.

The confidence may be associated with the actual sample data, such as pixels, as well as with information derived from it, such as the detection of object parts.

In addition to pixel uncertainties, characteristics of object parts (such as a poor contrast ratio with the object environment) may further complicate the evaluation. Taking uncertainties into account enables a reliable trajectory determination that can be quantified in terms of reliability (e.g. using a defined confidence measure), which can be particularly important e.g. for flight manoeuvres in sensitive areas of a facility (e.g. pipelines containing flammable substances).

Furthermore, a map according to the invention may also comprise additional information, such as an information indicating whether the map or the part of the map comprises a specific object part; an information indicating whether an object part has already been inspected, is currently being inspected, or is yet to be inspected; and/or a confidence of the respective information of the map or the part of the map. Generating and taking into account such additional information according to embodiments enables a coordination between a plurality of capturing units which e.g. scan the same object and access the same map. Similarly, a plurality of capturing units may update and/or expand a corresponding map.

A generated map or a part of a map may optionally be saved in a contiguous form, e.g. in the form of a matrix. In the case of a matrix, fields of the matrix may e.g. comprise a map section with a defined resolution and size, wherein corresponding map sections can be updated or created whenever a (e.g. optical) scan regarding that area is captured.

Reference is made again to FIG. 1. The grouping shown in FIG. 1 (the group 110 including the object parts 111 to 114 and the group 120 including the object parts 121 to 124) may also be used for trajectory planning according to embodiments.

For example, it is possible to detect that the first group of object parts has been fully scanned (e.g. that the group has been completely flown over and optically scanned; e.g. in the case of FIG. 1, when the capturing unit 200 continues to follow the trajectory direction, see 230, and has successively scanned the object parts 111, 112, 113 and finally 114), in order subsequently to generate a trajectory to the second group 120 of adjacent object parts. This may be done, in particular, using the map (but also using image analysis, or both). The evaluation that the end of a group has been reached may therefore also be based on scan data and/or prior information.

The following section describes further optional features of methods according to embodiments, which may e.g. enable a ‘fine determination’ or ‘fine tuning’ of the trajectory 230. For example, based on a scan corresponding to section 210, the second object part 112 may be detected, an information regarding the geometry of the second object part 112 may be obtained (e.g. using prior information) or determined, e.g. on the basis of an image analysis, and subsequently, based on the information regarding the geometry of the second object part 112, a relative inspection position of the movable capturing unit 200 for inspecting the second object part 112 may be determined, such that an associated (e.g. optical) scan comprises the second object part in a predetermined image area. The object part 112 may then be approached accordingly. In other words, the trajectory 230 may e.g. be adjusted to scan a specific object part within a specific image section, for instance to ensure a scan with a high degree of confidence. This means e.g., that precise inspection data can be generated. Similarly, such scans may be used to produce high-resolution map information.

It should be noted that the term ‘image’ and in particular ‘image section’ refers to a representation of the scan information or a corresponding subset of this information, irrespective of the specific scanning technique (e.g. optical, by radar, ultrasonic, etc.)

It should be noted here that the relative inspection position, and consequently the trajectory, nay also be determined using map information.

Another optional feature according to embodiments includes a dynamic adaptation of the trajectory 230 based on scanning and/or evaluation results. To illustrate this, the situation shown in FIG. 1 is considered, in which the capturing unit 200 is moving (e.g. based on map information) towards the object part 112 (e.g. during an approach) in order to perform a scan. For example, the object part 111 might have been added during a later phase of construction of the object 100, such that the map does not comprise any information regarding the part 111. Whilst moving, optionally the part 111 can now be detected, and it can also be determined that this part is to be scanned. To improve the efficiency of the method, optionally it is now possible to compare a distance between the capturing unit 200 and the first object part 111 with a distance between the capturing unit 200 and the further object part 112. In the case shown in FIG. 1, the part 111 would be closer to the capturing unit and would even be on the way towards the part 112.

Accordingly, the object part 111 may be used as a new starting point for executing the steps (a) to (c), as previously explained in the context of FIG. 1 (instead of using the part 112 as the ‘first’ object part).

With regard to an apparatus according to embodiments shown in FIG. 1 to 3, it should be summarised here once again that such an apparatus 200 for scanning a plurality of object parts of an object arranged adjacent to one another in an object environment may comprise the following features: a processing unit and a capturing unit, wherein the capturing unit is configured to be positioned at a first object part and to generate a (e.g. optical) scan of the first object part, wherein the processing unit is configured to determine a trajectory, e.g. a flight trajectory, towards a second object part adjacent to the first object part, wherein the (e.g. optical) scan of the first object part at least partially shows the second object part and/or wherein a relative location of the second object part to the first object part is known, and wherein the processing unit is configured to evaluate the (e.g. optical) scan of the first object part regarding a position of the second object part in order to determine the trajectory, and/or wherein the processing unit is configured to evaluate a map of the object environment with the object regarding a position of the second object part for determining the trajectory; and wherein the capturing unit is configured to move towards the second object part using the trajectory and to generate a (e.g. optical) scan of the second object part.

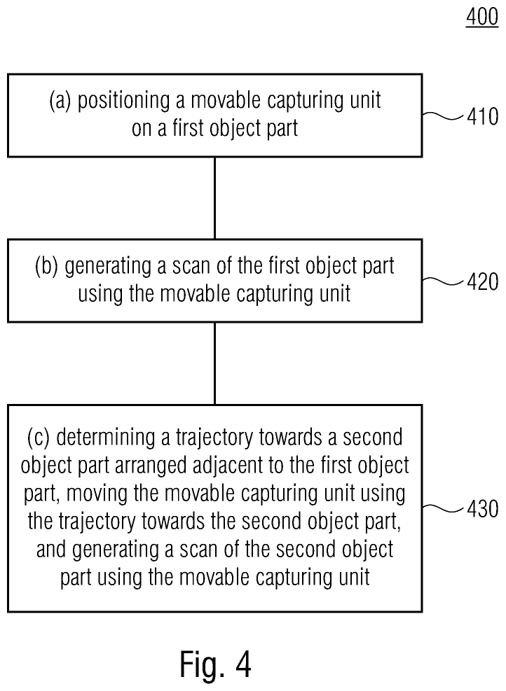

In summary, FIG. 4 shows a schematic block diagram of a method according to embodiments. FIG. 4 shows the method 400 for scanning a plurality of object parts of an object arranged adjacent to one another in an object environment, the method comprising the following steps:
(a) positioning 410 a movable capturing unit on a first object part; (b) generating 420 a (e.g. optical) scan of the first object part using a movable capturing unit; and (c) determining 430 a trajectory, e.g. a flight trajectory, towards a second object part arranged adjacent to the first object part, moving the movable capturing unit using the trajectory towards the second object part, and generating a (e.g. optical) scan of the second object part using the movable capturing unit.

The step (c) includes evaluating a map of the object environment with the object regarding a position of the second object part for determining the trajectory and/or evaluating the scan of the first object part regarding a position of the second object part for determining the trajectory. Furthermore, the scan generated in step (b) at least partially shows the second object part, and/or a relative location of the second object part relative to the first object part is known.

In the following, embodiments are explained again in different terms, and additional, optional features for embodiments are discussed.

Among other things, embodiments including scans in the form of optical scans and trajectories in the form of flight trajectories are discussed. However, as explained above with reference to a multitude of further examples of scans and capturing apparatuses, it should be clearly noted that the embodiments are not limited to such configurations.

The features described below may readily be applied in a similar manner to other embodiments, such as those addressing underwater applications involving underwater robots, or applications involving non-flying vehicles, such as wheeled or tracked vehicles. Similarly, the following features may also be applied to embodiments that use non-optical scanning, such as radar.

The following explanations also relate in particular to methods in which unmanned aerial vehicles (UAVs) can be used to explore, map and/or inspect flat unknown objects (e.g. as an example of a movable capturing unit). Outdoor photovoltaic systems are one example of a flat unknown object; however, the methods according to the invention are not limited to this.

Embodiments are discussed in particular within a functional framework. Such features may be added individually or in combination to the corresponding functions of the embodiments described above. In other words, some of the embodiments described earlier are explained in detail from a functional perspective.

Thus, methods according to embodiments may be divided into several sub-functions or may comprise one or more of these sub-functions: mapping, searching, fine-tuning, inspection.

These sub-functions are described below. The sequence of the steps shown, as well as the specific features, should be regarded as examples. Different sequences, as well as the use of only a subset of the features listed below, are readily possible according to embodiments.

### Mapping

1. (Optional step) For example, georeferenced maps may be created which may optionally show different states (i.e. e.g. additional information), such as one or more of the following:
   a. Includes the desired (or specified) object, does not include the desired (or specified) object, or is unknown, as well as gradations in between (e.g. based on confidences or classifications). For example, an object information may be stored in the map, linked, for instance, to the ID of an object part.
   b. Not inspected, currently being inspected, inspection completed. A real-time information regarding an inspection or scan may thus be registered in the map. This means for instance, that a multitude of capturing apparatuses may access a shared map in order to coordinate scanning and/or inspection.
   c. Confidence of the states in (a.)
2. (Optional step) Projection of the detected image (e.g. from optical scanning) onto the ground plane, taking into account additional information such as the measured distance to the ground. This may include correcting the recordings, for instance. For instance, the angle to the ground surface may also be taken into account during scanning.
3. (Optional step) Updating the map, e.g. in accordance with (1. a.) and/or (1. c.), using an update function that tolerates measuring errors or detection errors; an example of this would be a so-called Kalman filter.
   The confidence of individual pixels may be calculated e.g. using the distance, the angle between the line of sight of a pixel and the vertical line to the ground and/or other magnitudes of error.
   For instance, pixels with a line of sight perpendicular to the ground may be assigned a higher confidence than pixels whose line of sight forms a greater angle with the vertical line to the ground.
4. (Optional step) To enable a flexible recording of larger areas at high resolution, maps may be arranged in a contiguous form, such as a matrix. In this case, each field in this matrix may contain a map section, e.g. with a defined resolution and/or size. These map sections may be created as needed, e.g. when an image detected in this area is projected, i.e. e.g. when a scan is performed that comprises information regarding the relevant area. The projected images may then be cropped to match the map areas and e.g. optionally update the map areas individually (e.g. via (3.))

### Searching

1. (Optional step) Point the camera straight down.
2. (Optional step) The drone ascends to the next search level; see for example FIGS. 2 and 3.
   a. If the maximum height or specified minimum height is reached, change the viewing direction (e.g. starting from the viewing area 241, see FIG. 2), e.g. to a maximum of 30° (possibly more or less, depending on the field of view of the camera), deviating from the vertical downwards, rotate e.g. in 30-90° (also depending on the field of view of the camera) in steps around the vertical (downwards) (see e.g. the viewing areas 242, 243, 244). For instance, at each step, perform (3), (4) and/or (5), optionally only after a full rotation around the vertical.
3. (Optional step) Optical scanning, e.g. image capture (e.g. photos are georeferenced optionally).
4. (Optional step) Detecting, e.g. using artificial intelligence, whether (e.g. desired or specific) objects are spotted.
5. (Optional step) Mapping the detected image to the ground level, e.g. based on at least one of the following: current position, drone orientation, line of sight, and distance measurement.
6. (Optional step) Checking the maps:
   a. The desired object does not appear on the map or its estimated area is too small->continue with (2.).
   b. The desired object is found on the map with a sufficient estimated area->continue with (7.).
7. (Optional step) Estimating the starting position for inspecting the desired object.
8. (Optional step) Flying to the mapped position of the desired object whilst maintaining the distance from the ground; during the flight, e.g. at regular time intervals: Carrying out steps (3.), (4.) and/or (5.).
   a. If desired objects that are closer in space are detected during (4.) and (5.), optionally: Adjusting the target point to the position of this desired object (optional step).
9. (Optional step) Arriving over the desired object.

### Fine-Tuning

1. (Optional step) Based on recent images:
   a. Optical scanning, e.g. image capture (e.g. photos are georeferenced optionally) (optional step).
   b. Detecting (e.g. object detecting), e.g. using artificial intelligence, of (e.g. desired or specific) objects (optional step).
   c. Determining the nearest desired object in the horizontal direction (optional step).
   d. Determining the projected width of this object (optional step).
   e. Calculating the height, taking into account the desired width in the image (optional step).
   f. Calculating the central axis of the desired object, parallel to its sides (optional step).
   g. Projection of the drone position, as shown on the map, onto the central axis->determines e.g. the horizontal position (optional step).
   h. Flying to the calculated height and horizontal position, with orientation aligned e.g. parallel to the central axis (optional step).
2. (Optional step) Based on mapping:
   a. Copying from the map section, e.g. based on the line of sight and position of the drone, the field of view and/or the distance to the ground. (Optional step)
   b. (May be omitted, as it has already been detected, for instance.)
   c. Determining the nearest object horizontally (in the plane) (e.g. the desired object, for instance the next object to be inspected) (optional step).
   d. Determining the projected width of this object (optional step).
   e. Calculating the height, e.g. taking into account the desired width in the image (optional step).
   f. Calculating the central axis of the desired object, parallel to its sides (optional step).
   g. Projection of the drone position, as shown on the map, onto the central axis->determines the horizontal position (optional step).
   h. Flying to the calculated height and horizontal position (optional step).

### Inspection

1. (Optional step) Performing searches.
2. (Optional step) Performing fine-tuning.
3. (Optional step) For instance, continuously along the central axis (e.g. following fine-tuning) at desired distances (e.g. based on a fixed value or calculated using the drone's field of view and distance to the object, in order to seamlessly stitch the images together).
   a. Optical scanning, e.g. capturing images (e.g. photos are georeferenced optionally) (optional step).
   b. Detection (e.g. object detection), e.g. using artificial intelligence (optional step).
   c. Cutting out areas (in the current image) that have been marked as fully inspected in the mapping process (optional step).
   d. Determining whether the desired object (or group of objects or object part) is still within the upper image part (e.g. next flight positions, e.g. according to the planned trajectory) (optional step).
      i. If not, incrementing a counter; if the counter exceeds a maximum value, mark the area currently marked as inspected as fully inspected, then continue with (4.).
      ii. If present, set the counter to 0.
   e. Performing fine-tuning (e.g. including recalculation of the flight axis/central axis) (optional step).
   f. Marking the image area on the relevant map as having been inspected (optional step).
   g. Continue with (3.). (Optional step)
4. (Optional step) If the maximum height has been reached or the search area has been fully mapped, ending the inspection; otherwise, continue with (1.).

The following section discusses the details of the embodiments in different terms.

On the one hand, embodiments include a combination of mapping and scanning, such as inspection scanning. The inventors have recognised that e.g. even an initial mapping flight may be used to inspect recognised object parts, and conversely, a map may be continuously updated in parallel with an inspection. In particular, according to some embodiments, it may be advantageous to carry out such a mapping at greater distances from the object or object parts in order to quickly obtain an overview of the locations of the object parts. Furthermore, such a rough scan may e.g. already be sufficient for flight path planning, but may not be adequate for an inspection. Thus, according to the embodiments, the actual scanning may e.g. involve flying closer to the object parts. Using such higher-resolution scans, e.g. the first and/or second scan, it is then possible not only to carry out a reliable inspection, but also to refine the coarser map information. With reference to FIGS. 1 and 2, the height of the capturing unit 200 relative to the object could e.g. be much greater during mapping as shown in FIG. 2 than during an inspection as shown in FIG. 1.

It should also be noted once again that embodiments may make efficient use of prior location information to generate the scans and to plan trajectories. In this context, both a prior knowledge, such as a known distance between individual object parts, and knowledge generated during the mapping may be utilised. However, it is only when the aircraft takes off, e.g. as shown in FIG. 1, that the trajectory can be planned or, at the very least, adjusted. For instance, an image edge can be evaluated using image recognition to navigate towards other object parts of a group of objects. The capturing unit can therefore ‘trace’ a group of object parts.

Embodiments also enable, for instance, linking scan information with confidence measures, in addition to combining mapping (e.g. as rough information for coarse trajectory planning) and inspection (e.g. to generate ‘fine’, i.e. for instance precise scans for inspecting object parts and e.g. optionally in addition to the fine-tuning of trajectory planning). A metric may therefore be assigned to map information to estimate the reliability of the information. Such a measure may be determined e.g. on the basis of scanning distances and angles, as explained in detail above. At a basic level, this may e.g. relate to individual pixels, such as their associated location information. Furthermore, a corresponding confidence measure can optionally also be calculated for the information derived from this, i.e. e.g. the actual map information, such as classification results like ‘first object part’ or ‘group of objects’. In addition to physical scanning data, further boundary conditions of the classification may also be taken into account. For instance, as a safety measure, the area of an object part detected in a scan may be compared with the expected area for that object part, taking into account, for instance, that due to distortions resulting from an ‘oblique’ scan (see e.g. 242 in FIG. 2), the area of the object part in the scan may comprise errors (in line with the fundamental pixel errors explained previously). In this context, other factors, such as a contrast between the object and its environment, may also be taken into account in the scans.

This makes it possible to generate a map that can also be used to assess the safety of an inspection, e.g. when inspecting hazardous industrial facilities (where a drone should, for instance, avoid colliding with a gas pipeline at all costs, meaning its trajectory has to be as reliable as possible).

It should be noted here that the innovative concept of confidences goes hand in hand with the dual use of inspection scans, as ‘fine scans’may also be used to improve confidences for object parts.

It should also be noted that these embodiments enable inspection in the sense of a ‘fire-and-forget’ system. This means that the capturing unit may be positioned at a location within the object environments that is accessible only at the start of the mapping, with little or no prior information. The capturing unit may then first map the environment and, using the information gathered, carry out an inspection at the same time. Once this is done, not only will a map of the object and the object environment be available, but also the inspection result. Embodiments therefore allow for a great deal of flexibility in their application.

It should also be noted that a change in the object parts from which an inspection trajectory is initiated may be carried out for instance on the basis of an optimisation of the overall trajectory. For instance, the efficiency of the trajectory may be improved online using map data and new data obtained during an inspection scan.

All lists of materials, environmental factors, electrical properties and optical properties set out herein are to be regarded as illustrative and not final.

Although some aspects have been described in connection with an apparatus, it is understood that these aspects also constitute a description of the corresponding method, so that a block or component of an apparatus is also to be understood as a corresponding method step or as a feature of a method step. Similarly, aspects described in connection with or as a method step also constitute a description of a corresponding block or detail or feature of a corresponding device. Some or all of the method steps may be performed by a hardware apparatus (or using a hardware apparatus), such as a microprocessor, a programmable computer or an electronic circuit. In some embodiments, some or more of the key method steps may be performed by such an apparatus.

Depending on specific implementation requirements, embodiments of the invention may be implemented in hardware or in software. The implementation may be carried out using a digital storage medium, for example a floppy disc, a DVD, a Blu-ray disc, a CD, a ROM, a PROM, an EPROM, an EEPROM or a FLASH memory, a hard disk or another magnetic or optical memory, on which electronically readable control signals are stored, which can or do interact with a programmable computer system in such a way that the respective method is carried out. The digital storage medium may therefore be computer-readable.

Thus, some embodiments according to the invention include a data carrier having electronically readable control signals capable of interacting with a programmable computer system such that one of the methods described herein is carried out.

In general, embodiments of the present invention may be implemented as a computer program product which includes a program code, wherein the program code is operative to perform one of the methods when the computer program product is running on a computer.

The program code may also be stored on a machine-readable medium, for example.

Other embodiments include the computer program for performing any of the methods described herein, wherein the computer program is stored on a machine-readable medium.

In other words, an embodiment of the method according to the invention is thus a computer program which comprises a program code for performing one of the methods described herein when the computer program is running on a computer.

A further embodiment of the methods according to the invention is thus a data carrier (or a digital storage medium or a computer-readable medium) on which the computer program for carrying out one of the methods described herein is recorded. The data carrier, digital storage medium or computer-readable medium is typically physical and/or non-perishable or non-transitory.

Thus, a further embodiment of the method according to the invention is a data stream or a sequence of signals representing the computer program for carrying out one of the methods described herein. The data stream or the sequence of signals may, for example, be configured to be transferred via a data communication link, for example via the Internet.

A further embodiment includes a processing device, such as a computer or programmable logic device, configured or adapted to carry out any of the methods described herein.

Another embodiment includes a computer on which the computer program for carrying out one of the methods described herein is installed.

A further embodiment according to the invention includes an apparatus or system adapted to transmit a computer program to a receiver for carrying out at least one of the methods described herein. The transmission may be electronic or optical, for example. The receiver may be, for example, a computer, a mobile device, a storage device or a similar device. For example, the apparatus or system may include a file server for transferring the computer program to the receiver.

In some embodiments, a programmable logic device (for example, a field programmable gate array, a FPGA) may be used to perform some or all of the functionalities of the methods described herein. In some embodiments, a field programmable gate array may interact with a microprocessor to carry out any of the methods described herein. In general, in some embodiments, the methods are carried out by any hardware device. This can be universally applicable hardware such as a computer processor (CPU) or hardware specific to the process, such as an ASIC.

The devices described herein may be implemented, for example, using a hardware device, or using a computer, or using a combination of a hardware device and a computer.

The devices described herein, or any components of the devices described herein, may be implemented at least partially in hardware and/or in software (a computer program).

The methods described herein may be implemented, for example, using a hardware device, or using a computer, or using a combination of a hardware device and a computer.

The methods described herein, or any components of the methods described herein, may be implemented at least partially by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Method for scanning a plurality of object parts of an object arranged adjacent to one another in an object environment, the method comprising:
(a) positioning a movable capturing unit on a first object part;
(b) generating a scan of the first object part using the movable capturing unit; and
(c) determining a trajectory towards a second object part arranged adjacent to the first object part, moving the movable capturing unit using the trajectory towards the second object part, and generating a scan of the second object part using the movable capturing unit;
wherein the step (c) comprises evaluating a map of the object environment with the object regarding a position of the second object part for determining the trajectory, and/or
wherein the step (c) comprises evaluating the scan of the first object part regarding a position of the second object part for determining the trajectory,
wherein the scan generated in step (b) at least partially shows the second object part, and/or
wherein a relative location of the second object part relative to the first object part is known.

2. The method according to claim 1, wherein the step (a) further comprises:
acquiring or determining an information regarding a position of the first object part; and
moving the movable capturing unit towards the first object part using the information regarding the position of the first object part.

3. The method according to claim 2, further comprising:
determining the information regarding the position of the first object part based on the map; and/or
positioning the capturing unit in a predetermined relative location to the first object part and providing an information regarding the predetermined relative location as information regarding the position of the first object part; and/or
positioning the capturing unit near the first object part so that the capturing unit can detect the first object part and determine an information regarding the position of the first object part.

4. The method according to claim 1, further comprising:
generating the map of the object environment with the object;
wherein generating the map of the object environment with the object is carried out based on the current position, an orientation and/or a distance measurement of the movable capturing unit.

5. The method according to claim 1, further comprising:
moving the movable capturing unit to a first mapping position;
generating and evaluating a scan of at least a part of the object environment with at least a part of the object;
updating the map and/or generating at least a part of a or the map of the object environment with the object based on the evaluation of the scan; and
provided that the map comprises an information, for example, an information that meets a predetermined confidence measure, regarding the position of the first and/or second object part,
determining the information regarding the position of the first object part using the map; and/or
determining an information regarding the position of the second object part using the map for determining the trajectory; and
otherwise or in addition
moving the movable capturing unit to a further mapping position;
generating and evaluating a further scan of at least a part of the object environment with at least a part of the object; and
updating the map and/or generating at least a further part of the map of the object environment with the object based on the evaluation of the further scan.

6. The method according to claim 5, further comprising:
orienting a scanning unit of the capturing unit substantially perpendicular to a surface of the object environment; and
generating the scan of at least a part of the object environments during moving the movable capturing unit to the first mapping position.

7. The method according to claim 5,
wherein updating the map and/or generating at least a part of the map of the object environment with the object based on the evaluation of the scan further comprises determining a confidence measure for parts of the map associated with the scan.

8. The method according to claim 7,
wherein the confidence measure for associated parts of the map is determined based on a distance and/or an angle between a line of sight of the capturing unit and a vertical line to the ground.

9. The method according to claim 5,
wherein updating the map and/or generating at least a part of the map of the object environment with the object and/or determining confidence measures is carried out by means of a stochastic filter to account for erroneous scanning results.

10. The method according to claim 1, further comprising:
detecting the first and/or second object part in a scan and determining a confidence measure for the detection of the first and/or second object part.

11. The method according to claim 1, further comprising:
updating the map based on scanning the first and/or second object part.

12. The method according to claim 1,
wherein the object comprises a plurality of groups of object parts arranged adjacent to one another, wherein a first group of object parts comprises at least the first and second object parts; and
wherein the method further comprises
moving the movable capturing unit along the first group of object parts and scanning the first group of object parts;
determining that the first group of object parts has been fully scanned; and
determining a trajectory towards a second group of object parts arranged adjacent to one another based on the map.

13. The method according to claim 1,
wherein the map or a part of the card comprises additional information, wherein the additional information comprises at least one of
an information as to whether the map or the part of the map comprises a specific object part;
an information as to whether an object part has already been inspected, is currently being inspected, or is still to be inspected; and/or
a confidence of the relevant information of the map or the part of the map.

14. The method according to claim 1,
wherein the scan generated in step (b) at least partially shows the second object part; and
wherein the method further comprises:
detecting the second object part in the scan generated in step (b);
acquiring an information regarding a geometry of the second object part;
determining, based on the information regarding the geometry of the second object part, a relative inspection position of the movable capturing unit for inspecting the second object part, such that an associated scan comprises the second object part within a predetermined image area; and
moving the movable capturing unit to the relative inspection position.

15. The method according to claim 1,
wherein evaluating the map of the object environment with the object regarding a position of the second object part further comprises:
acquiring an information regarding a geometry of the second object part;
determining a relative inspection position of the movable capturing unit for inspecting the second object part, such that an associated scan comprises the second object part within a predetermined image area; and
wherein the method further comprises moving the movable capturing unit to the relative inspection position.

16. The method according to claim 1, further comprising:
detecting, whilst moving the movable capturing unit to the first object part, a further object part to be scanned,
comparing the distance between the capturing unit and the first object part with the distance between the capturing unit and the further object part;
replacing the first object part with the further object part in order to carry out steps (a) to (c).

17. The method according to claim 1,
wherein the object is an outdoor photovoltaic system with a plurality of photovoltaic panels arranged adjacent to one another.

18. The method according to claim 1, further comprising:
inspecting the first object part by scanning the first object part; and/or
inspecting the second object part by scanning the second object part.

19. A non-transitory digital storage medium having a computer program stored thereon to perform the method for scanning a plurality of object parts of an object arranged adjacent to one another in an object environment, the method comprising:
(a) positioning a movable capturing unit on a first object part;
(b) generating a scan of the first object part using the movable capturing unit; and
(c) determining a trajectory towards a second object part arranged adjacent to the first object part, moving the movable capturing unit using the trajectory towards the second object part, and generating a scan of the second object part using the movable capturing unit;
wherein the step (c) comprises evaluating a map of the object environment with the object regarding a position of the second object part for determining the trajectory, and/or
wherein the step (c) comprises evaluating the scan of the first object part regarding a position of the second object part for determining the trajectory,
wherein the scan generated in step (b) at least partially shows the second object part, and/or
wherein a relative location of the second object part relative to the first object part is known,
when said computer program is run by a computer.

20. Apparatus for scanning a plurality of object parts of an object arranged adjacent to one another in an object environment,
wherein the apparatus comprises a processing unit and a capturing unit;
wherein the capturing unit is configured to be positioned at a first object part and to generate a scan of the first object part;
wherein the processing unit is configured to determine a trajectory towards a second object part adjacent to the first object part;
wherein the scan of the first object part at least partially shows the second object part and/or wherein a relative location of the second object part relative to the first object part is known, and wherein the processing unit is configured to evaluate the scan of the first object part regarding a position of the second object part for determining the trajectory; and/or
wherein the processing unit is configured to evaluate a map of the object environment with the object regarding a position of the second object part for determining the trajectory; and
wherein the capturing unit is configured to move towards the second object part using the trajectory and to generate a scan of the second object part.
